(19) United States
(12) Patent Application Publication
(10) Pub. No.: US 2015/0091555 A1
(43) Pub. Date: Apr. 2, 2015

(54) APPARATUS FOR DETECTING MAGNETIC FLUX LEAKAGE SIGNALS

(71) Applicant: Tsinghua University, Beijing (CN)

(72) Inventors: Songling Huang, Beijing (CN); Wei Zhao, Beijing (CN); Shen Wang, Beijing (CN); Qun Liu, Beijing (CN)

(73) Assignee: TSINGHUA UNIVERSITY, Beijing (CN)

(21) Appl. No.: 14/262,999

(22) Filed: Apr. 28, 2014

(30) Foreign Application Priority Data
Sep. 30, 2013 (CN) 201310460761.0

(51) Int. Cl. G01N 27/82

(52) U.S. Cl. CPC G01N 27/82
USPC 324/209

(57) ABSTRACT

An apparatus for detecting magnetic flux leakage signals is provided. The apparatus includes: M three-axis magnetic field sensors configured to detect a three-dimensional magnetic field intensity in M locations respectively to obtain M three-dimensional magnetic field intensity data, in which M is an integer larger than three; a field programmable gate array configured to receive and process the M three-dimensional magnetic field intensity data respectively; a main control chip configured to receive and pack the processed M three-dimensional magnetic field intensity data; and a data output interface configured to output the packed M three-dimensional magnetic field intensity data.

### CROSS REFERENCE TO RELATED APPLICATION

This application claims priority and benefits of Chinese Patent Application No. 201310460761.0, filed with State Intellectual Property Office on Sep. 30, 2013, the entire content of which is incorporated herein by reference.

### FIELD

Embodiments of the present disclosure generally relate to a signal detecting apparatus, and more particularly, to an apparatus for detecting magnetic flux leakage signals.

### BACKGROUND

As a common ferromagnetic material, steel is widely used in the national economic construction. However, since many steel products are eroded and acted on a load by an external environment during operations, materials in the steel products may have defects, thus causing a structure or shape change of the materials. Performing a magnetic flux leakage detection on ferromagnetic material products to find out defects therein is a most commonly used nondestructive examination technology. Currently, in the related art, three one-dimensional magnetic field sensors mounted together closely are configured to detect magnetic field components in three directions vertical to each other, namely a radial direction, an axial direction and a circumferential direction, so as to implement a three-dimensional magnetic flux leakage detection. However, limited to an own size of the one-dimensional magnetic field sensor, detecting points of the three one-dimensional magnetic field sensors cannot coincide with each other as a same point, and a distance between each two one-dimensional magnetic field sensors is at least 3 mm to 4 mm. Therefore, when detecting a three-dimensional magnetic flux field in a location, one-dimensional magnetic flux fields in three different locations are obtained in fact, thus resulting in a position error. Meanwhile, a multiplexing mode is adopted in the above description, and each one-dimensional magnetic field sensor is gated at different time, thus resulting in a time difference between different one-dimensional magnetic field sensors when detecting the three-dimensional magnetic flux field. Consequently, the detecting result is not accurate.

### SUMMARY

Embodiments of the present disclosure seek to solve at least one of the problems existing in the related art to at least some extent.

Embodiments of the present disclosure provide an apparatus for detecting magnetic flux leakage signals with a high spatial precision and a synchronous multiplex data acquisition. The apparatus has a good anti-interference capability, a high detecting precision and a simple structure, and is easy to operate.

Embodiments of a first broad aspect of the present disclosure provide an apparatus, including: M three-axis magnetic field sensors configured to detect a three-dimensional magnetic field intensity in M locations respectively to obtain M three-dimensional magnetic field intensity data, in which M is an integer larger than three; a field programmable gate array configured to receive and process the M three-dimensional magnetic field intensity data respectively; a main control chip configured to receive and pack the processed M three-dimensional magnetic field intensity data; and a data output interface configured to output the packed M three-dimensional magnetic field intensity data.

In some embodiments, the field programmable gate array has a plurality of input ports configured to receive the M three-dimensional magnetic field intensity data in parallel.

In some embodiments, the field programmable gate array has M output ports configured to output the processed M three-dimensional magnetic field intensity data in parallel, and the main control chip has M input ports configured to receive the processed M three-dimensional magnetic field intensity data in parallel.

In some embodiments, processing the M three-dimensional magnetic field intensity data respectively includes: converting each of the M three-dimensional magnetic field intensity data to obtain M three-dimensional magnetic field intensity data in a same data format and sequencing the M three-dimensional magnetic field intensity data in the same data format.

In some embodiments, packing the processed M three-dimensional magnetic field intensity data includes: recording a current detecting time; packing the detecting time into each of the M three-dimensional magnetic field intensity data.

In some embodiments, each of the M three-axis magnetic field sensors has an independent gated port configured to receive a control signal sent from the field programmable gate array and to control each of the M three-axis magnetic field sensors to detect a three-dimensional magnetic field intensity at a corresponding position.

In some embodiments, first pins of the M three-axis magnetic field sensors connected in parallel, a VCC port of the field programmable gate array and a VCC port of the main control chip are connected with a predetermined power source; second pins of the M three-axis magnetic field sensors connected in parallel, a GND port of the field programmable gate array and a GND port of the main control chip are grounded; a third pin of each of the M three-axis magnetic field sensors is connected with one of the plurality of input ports of the field programmable gate array respectively; a fourth pin of each of the M three-axis magnetic field sensors is connected with one of the plurality of input ports of the field programmable gate array respectively; the M output ports of the field programmable gate array are connected with the M input ports of the main control chip respectively; a USB_VBUS port of the main control chip is connected with a VBUS port of the data output interface, a USB_DM port of the main control chip is connected with a D− port of the data output interface and a USB_DP port of the main control chip is connected with a D+ port of the data output interface.

In some embodiments, the M three-axis magnetic field sensors are mlx90393 chips.

In some embodiments, the field programmable gate array is an EP1C6T144C6 chip.

In some embodiments, the main control chip is a LPC3131 chip.

In embodiments of the present disclosure, a number of the three-axis magnetic field sensors may be adjusted according to a size of an object to be detected, such that the three-axis magnetic field sensor can be well adapted to different detecting precisions. The field programmable gate array has a plurality of 10 ports functioning as a relay for processing and sending data, thus meeting the requirement of inputting and outputting multiplex data in parallel. The main control chip sends data in a USB mode with a high transmission speed, which is not easy to be interfered.

Main features of embodiments of the present disclosure are as follows:
1) The three-dimensional magnetic field of the material defect is detected and positioned accurately, and the detecting precision is high.
2) Magnetic field components in three directions vertical to each other of a certain location in the space are detected accurately, and a magnetic field distribution inverted through detected data coincides with an actual condition better.
3) A gating time delay of the magnetic field sensor is avoided, and a synchronous multiplex data acquisition is realized.
4) The apparatus has a simple structure and is easy to operate and maintain.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the accompanying drawings, in which:

FIG. 1 is schematic diagram showing a structure of an apparatus for detecting magnetic flux leakage signals according to an embodiment of the present disclosure;

FIG. 2 is a schematic diagram showing a circuit principle of an apparatus for detecting magnetic flux leakage signals according to an embodiment of the present disclosure.

### DETAILED DESCRIPTION

An apparatus for detecting magnetic flux leakage signals will be described in the following with reference to drawings and embodiments of the present disclosure.

In an embodiment of the present disclosure, the apparatus for detecting magnetic flux leakage signals includes eight three-axis magnetic field sensors, i.e., M being equal to eight is taken as an example to describe the embodiment of the present disclosure. It should be understood that, in other embodiments of the present disclosure, the number M of the three-axis magnetic field sensors is an integer larger than three, and can be set according to detecting requirements and is not limited to the embodiment.

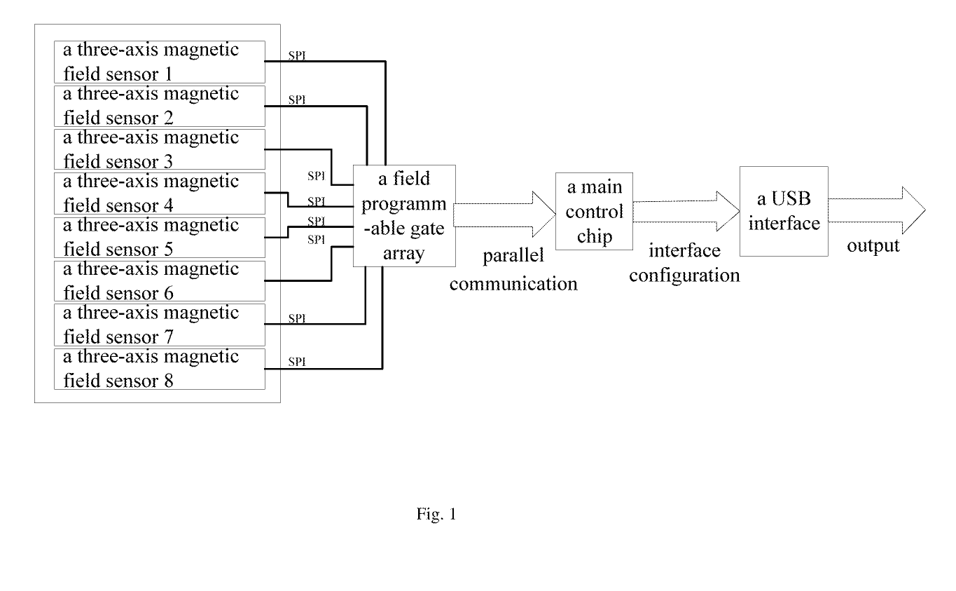

FIG. 1 is schematic diagram showing a structure of an apparatus for detecting magnetic flux leakage signals according to an embodiment of the present disclosure.

With reference to FIG. 1, the apparatus for detecting magnetic flux leakage signals includes eight three-axis magnetic field sensors, a field programmable gate array, a main control chip and a data output interface.

The eight three-axis magnetic field sensors are configured to detect a three-dimensional magnetic field intensity in eight locations respectively to obtain eight three-dimensional magnetic field intensity data.

The field programmable gate array is configured to receive and process the eight three-dimensional magnetic field intensity data respectively. Specifically, the field programmable gate array converts the eight three-dimensional magnetic field intensity data so as to obtain eight three-dimensional magnetic field intensity data in a same format, and sequences the eight three-dimensional magnetic field intensity data in the same format.

The main control chip is configured to receive and pack the processed eight three-dimensional magnetic field intensity data. Specifically, the main control chip records a current detecting time and packs the current detecting time into each three-dimensional magnetic field intensity data respectively.

The data output interface is configured to output the packed eight three-dimensional magnetic field intensity data.

The field programmable gate array has a plurality of input ports. The plurality of input ports are connected with an output port of each three-axis magnetic field sensor and are configured to receive the eight three-dimensional magnetic field intensity data in parallel. The field programmable gate array has eight output ports and the main control chip has eight input ports. The eight output ports of the field programmable gate array are connected with the eight input ports of the main control chip respectively so as to output the processed eight three-dimensional magnetic field intensity data to the main control chip in parallel. An output port of the main control chip is connected with the data output interface, and the data output interface outputs the data via external cables.

In an embodiment of the present disclosure, the data output interface is a USB interface.

Each of the eight three-axis magnetic field sensors has an independent gated port. The independent gated port is configured to receive a control signal sent from the field programmable gate array, and the three-axis magnetic field sensor controls itself to sense and detect the magnetic field intensities in the three directions vertical to each other in a location where the three-axis magnetic field sensor is located. Each of the eight three-axis magnetic field sensors outputs the three-dimensional magnetic field intensity data to the field programmable gate array via a SPI data communication protocol.

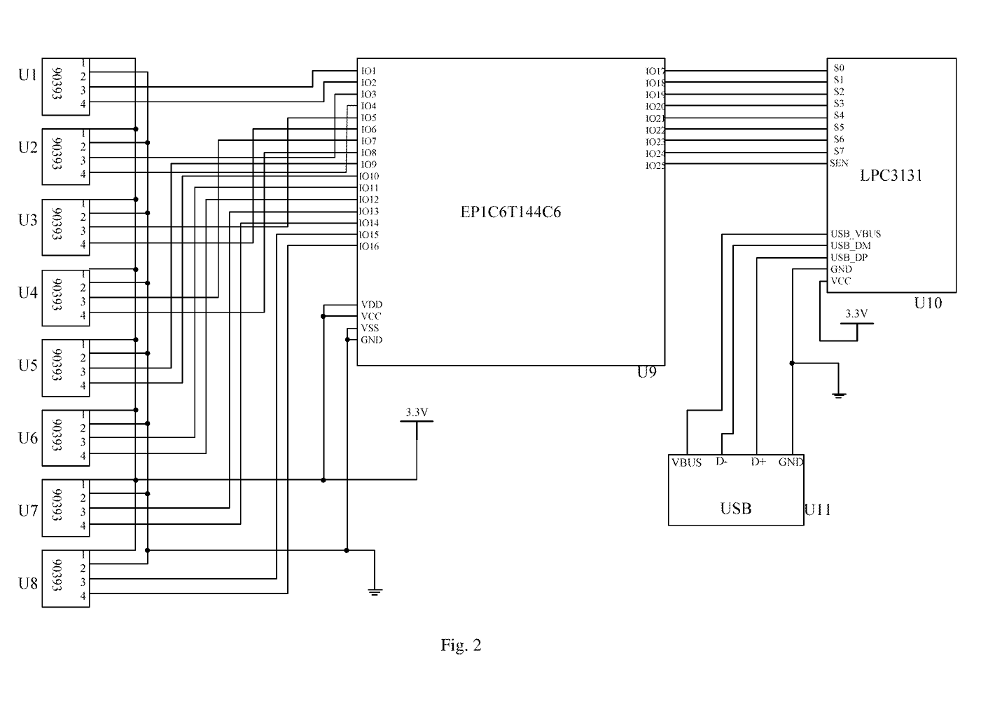

FIG. 2 is a schematic diagram showing a circuit principle of an apparatus for detecting magnetic flux leakage signals according to an embodiment of the present disclosure.

As shown in FIG. 2, first pins of the eight three-axis magnetic field sensors U1-U8 connected in parallel, a VCC port of the field programmable gate array U9 and a VCC port of the main control chip U10 are connected with a predetermined power source 3.3V. Second pins of the eight three-axis magnetic field sensors U1-U8 connected in parallel, a GND port of the field programmable gate array U9 and a GND port of the main control chip U10 are grounded. A third pin and a fourth pin of each of the eight three-axis magnetic field sensors are connected with one of general IO ports 101-1016 of the field programmable gate array U9 respectively. General IO ports U17-U24 of the field programmable gate array U9 are connected with the eight input ports S0-S7 of the main control chip U10 respectively. A USB_VBUS port of the main control chip U10 is connected with a VBUS port of the data output interface, a USB_DM port of the main control chip U10 is connected with a D− port of the data output interface and a USB_DP port of the main control chip U10 is connected with a D+ port of the data output interface.

In an embodiment of the present disclosure, the data output interface is a USB interface.

The eight three-axis magnetic field sensors U1-U8 are mlx90393 chips.

The field programmable gate array U9 is an EP1C6T144C6 chip.

The main control chip U10 is a LPC3131 chip.

The principle of embodiments of the present disclosure is as follows.

The field programmable gate array controls the three-axis magnetic field sensors to detect the three-dimensional magnetic field intensities according to a detecting instruction sent from the main control chip. After detecting the three-dimensional magnetic field intensities, the three-axis magnetic field sensor sends the three-dimensional magnetic field intensity data to the field programmable gate array via the SPI data communication protocol. The field programmable gate array receives the three-dimensional magnetic field intensity data sent from the three-axis magnetic field sensors and sequences the three-dimensional magnetic field intensity data in a certain order, and then sends the data to the main control chip in an 8-bit data format. The main control chip receives the data sent from the field programmable gate array and packs information during detection such as the detecting time into the data, and then sends the data via the data output interface, i.e., via the USB interface.

In embodiments of the present disclosure, eight three-axis magnetic field sensors are used and each of the eight three-axis magnetic field sensors can independently detect the magnetic flux signals in the three directions vertical to each other in a certain location in the space. The field programmable gate array controls the three-axis magnetic field sensors to detect the three-dimensional magnetic field intensities and communicates with each three-axis magnetic field sensor independently without influencing other sensors, thus implementing a data acquisition, a data transmission or a data reception at a same time. Compared with other apparatus for detecting the magnetic flux leakage signals, the number of the magnetic field sensors used in embodiments of the present disclosure is one third of that of the other apparatus. Meanwhile, the three-dimensional magnetic field intensity data in the certain location in the space can be detected accurately, and the three-dimensional magnetic field intensity data in different locations in the space can be detected at a same time.

According to embodiments of the present disclosure, the apparatus has a simple structure and a good generality, and is easy to maintain.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

1. An apparatus for detecting magnetic flux leakage signals, comprising:
M three-axis magnetic field sensors configured to detect a three-dimensional magnetic field intensity in M locations respectively to obtain M three-dimensional magnetic field intensity data, in which M is an integer larger than three;
a field programmable gate array configured to receive and process the M three-dimensional magnetic field intensity data respectively;
a main control chip configured to receive and pack the processed M three-dimensional magnetic field intensity data; and
a data output interface configured to output the packed M three-dimensional magnetic field intensity data.

2. The apparatus according to claim 1, wherein the field programmable gate array has a plurality of input ports configured to receive the M three-dimensional magnetic field intensity data in parallel.

3. The apparatus according to claim 2, wherein the field programmable gate array has M output ports configured to output the processed M three-dimensional magnetic field intensity data in parallel;
the main control chip has M input ports configured to receive the processed M three-dimensional magnetic field intensity data in parallel.

4. The apparatus according to claim 3, wherein processing the M three-dimensional magnetic field intensity data respectively comprises:
converting each of the M three-dimensional magnetic field intensity data to obtain M three-dimensional magnetic field intensity data in a same data format and sequencing the M three-dimensional magnetic field intensity data in the same data format.

5. The apparatus according to claim 1, wherein packing the processed M three-dimensional magnetic field intensity data comprises:
recording a current detecting time;
packing the detecting time into each of the M three-dimensional magnetic field intensity data.

6. The apparatus according to claim 1, wherein each of the M three-axis magnetic field sensors has an independent gated port configured to receive a control signal sent from the field programmable gate array and to control each of the M three-axis magnetic field sensors to detect a three-dimensional magnetic field intensity at a corresponding position.

7. The apparatus according to claim 3, wherein
first pins of the M three-axis magnetic field sensors connected in parallel, a VCC port of the field programmable gate array and a VCC port of the main control chip are connected with a predetermined power source;
second pins of the M three-axis magnetic field sensors connected in parallel, a GND port of the field programmable gate array and a GND port of the main control chip are grounded;
a third pin of each of the M three-axis magnetic field sensors is connected with one of the plurality of input ports of the field programmable gate array respectively;
a fourth pin of each of the M three-axis magnetic field sensors is connected with one of the plurality of input ports of the field programmable gate array respectively;
the M output ports of the field programmable gate array are connected with the M input ports of the main control chip respectively;
a USB_VBUS port of the main control chip is connected with a VBUS port of the data output interface, a USB_DM port of the main control chip is connected with a D− port of the data output interface and a USB_DP port of the main control chip is connected with a D+ port of the data output interface.

8. The apparatus according to claim 7, wherein the M three-axis magnetic field sensors are mlx90393 chips.

9. The apparatus according to claim 7, wherein the field programmable gate array is an EP1C6T144C6 chip.

10. The apparatus according to claim 7, wherein the main control chip is a LPC3131 chip.

11. The apparatus according to claim 1, wherein the M three-axis magnetic field sensors output the three-dimensional magnetic field intensity data via a SPI data communication protocol.
